(19) United States
(12) Patent Application Publication
(10) Pub. No.: US 2010/0304268 A1
(43) Pub. Date: Dec. 2, 2010

(54) TERNARY ALLOY CATALYSTS FOR FUEL CELLS

(76) Inventors: Tetsuo Kawamura, South-Glastonbury, CT (US); Lesia Protsailo, Bolton, CT (US)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/473,550

(22) Filed: May 28, 2009

(51) Int. Cl. H01M 4/00; H01M 4/88; B01J 23/652; B01J 23/745; B01J 23/75; B01J 23/60; B01J 23/755; B01J 23/42; B01J 23/72; B01J 23/656

(52) U.S. Cl. 429/483; 502/101; 502/313; 502/324; 502/326; 502/329; 502/331; 502/339; 429/487

(57) ABSTRACT

Alloy catalysts have the formula of PtᵢIrⱼXₖ, wherein X represents an element from the group consisting of Ti, Mn, Co, V, Cr, Ni, Cu, Zr, Zn, and Fe. These catalysts can be used as electrocatalysts in fuel cells.

### FIELD OF THE INVENTION

This invention relates to ternary alloy catalysts, especially alloy catalysts containing platinum, iridium, and a third element, for use in fuel cells, as well as related methods of synthesis.

### BACKGROUND OF THE INVENTION

A fuel cell is an electrochemical device in which a fuel is oxidized to generate electricity. It comprises an anode, a cathode, and an electrolyte. The anode and cathode comprise catalysts that promote electrochemical reactions. In a polymer electrolyte membrane fuel cell (PEMFC) or a phosphoric acid fuel cells (PAFC), the fuel, often hydrogen, dissociates at the anode in the presence of the anode electrocatalyst to form protons and electrons. The protons migrate through the electrolyte and reach the cathode, where the cathode electrocatalyst facilitates the reaction between oxygen and protons to form water. The electrons, on the other hand, flow from the anode to the cathode through an external electrical circuit. This electrical current can be used to carry an electrical load. The electrolyte in a PEMFC is a polymeric membrane. In a PAFC, the electrolyte is concentrated phosphoric acid.

The electrocatalysts are highly active in facilitating their respective reactions but also have to endure the highly corrosive environment. Noble metal catalysts, e.g., platinum and it alloys, are the catalysts of choice. But platinum is very expensive. Researchers have been seeking ways to reduce the content of platinum or other expensive noble metals in electrocatalysts. One related approach to accomplish this result is to reduce the particle size of the metal catalyst so that, with the same amount of noble metal, the catalyst with smaller particle sizes has a larger electrochemical surface area (ECA). A larger ECA indicates that more active sites are present on the catalyst surface and accessible to the reactant molecules. Other conditions being the same, a catalyst with a larger ECA is more active than one with a smaller ECA.

Another related approach to reduce noble metal content in an electrocatalyst is to use substitutes for platinum or dopants so that the same level of catalytic activity is maintained using a smaller amount of noble metal. Both approaches are employed in developing active and stable electrocatalysts.

Electrocatalysts may deactivate over time. Ternary alloy catalysts having platinum, iridium, and a third element X were reported to be suitable electrocatalysts in U.S. Pat. No. 5013,618. However, the same patent indicates that the catalyst was not stable and suffered large losses in surface area during testing.

One of the mechanisms for catalyst deactivation is coalescing of small catalyst particles to form large particles (also known as sintering) over time on stream, causing loss of ECA and loss of catalytic activity. Reducing catalyst sintering can prevent or slow down this mode of catalyst deactivation. Another mechanism for catalyst deactivation is through the dissolution of the catalyst, such as platinum, into the electrolyte or water in the fuel cell. A unstable catalyst may suffer from one or both modes of deactivation.

### SUMMARY OF THE INVENTION

The present disclosure is generally directed to a ternary alloy metal catalyst, which has high activity and stability. The catalyst comprises platinum, iridium, and one other element X, i.e., PtᵢIrⱼXₖ. Another aspect of the present disclosure is directed to a PAFC or a PEMFC that employs this catalyst as an electrocatalyst.

There is also disclosed a method of synthesizing a ternary alloy metal catalyst comprising platinum and iridium, as well as a method of using this alloy metal catalyst in a PAFC or a PEMFC.

Various embodiments of the present disclosure can be used in fuel cells and other similar or related applications. It is to be understood that the present invention is not limited by the embodiments described herein. Other features and advantages of the present invention will become more apparent from the following detailed description of the invention when taken alone or in conjunction with the accompanying exemplary drawing.

### BRIEF DESCRIPTION OF THE DRAWINGS

FIG. 1 compares the specific activity and the ECA loss of an example catalyst of claimed invention with those of a reference catalyst.

### DETAILED DESCRIPTION OF THE PREFERRED EMBODIMENTS OF THE INVENTION

The present disclosure is generally directed to ternary catalysts comprising platinum and iridium that can be used in a wide variety of applications. While the following discussion exemplifies fuel cell applications, especially in PEMFC or PAFC, the disclosure is not so limited. Rather, it is appreciated that the disclosure broadly encompasses any application that could utilize the stable and active catalyst having a specific composition. Therefore, while the invention described below is directed to a PEMFC or a PAFC electrocatalyst comprising platinum and iridium, it is to be understood that the present invention is applicable to other types of fuel cells or catalytic reactions where this catalyst can be used.

The catalyst of the present invention has a composition PtᵢIrⱼXₖ, wherein X represents an element selected from the group consisting of Ti, Mn, Co, V, Cr, Ni, Cu, Zr, Zn, and Fe. The molar percentage of Pt, Ir, and X are represented by i, j, and k respectively. The molar percentage is based on the total mole number of Pt, Ir, and X in the ternary alloy.

As broadly embodied herein, increasing the content of X in a certain range results in shorter Pt—Pt bond and reduces the loss in ECA by reducing Pt dissolution during fuel cell operation. In a preferred embodiment of the catalyst, i is between 40 mol % and 60 mol %, j is between 5 mol % and 20 mol %, and k is between 30 mol % and 50 mol %. In another preferred embodiment, i is between 40 mol % and 60 mol %, j is between 5 mol % and 20 mol %, and k is between 35% and 50%. In still other preferred embodiments, i is between 40 mol % and 50 mol % and/or j is between 5 mol % and 10 mol %.

The catalyst can be deposited onto a catalyst support material, e.g., carbon black. The weight of the alloy catalyst is preferably in the range of 20 wt % to 60 wt % of the total weight of the catalyst and the catalyst support. The catalyst particle size is preferably between 30 Å to 90 Å.

The catalyst of the present invention may be made by any of a variety of methods. In one of the preferred methods, one or more water soluble compounds of the metal elements, i.e., Pt, Ir, or X, are mixed with a carbon support in an aqueous solution. Then a reducing agent selected from the group consisting of hydrazine, sodium borohydride, formic acid, and formaldehyde is added to the aqueous solution. Subsequently, the metals precipitates in the form of metal salts or organometallic complexes and deposit on the carbon support. The liquid in the solution is then evaporated in a vacuum chamber to obtain a solid material, which contains metal catalyst precursors on the carbon support. If all metal precursors are not deposited in one step, the above process may be repeated until all metal precursors are deposited onto the carbon support.

The solid material obtained in the vacuum chamber is then calcined in an inert atmosphere at 600-1000° C. for 0.5-5 hrs before cooling down to room temperature. The resulting supported catalyst may be characterized to determine the composition of the catalyst, the specific activity, the lattice constant, and electrochemical surface area (ECA), etc.

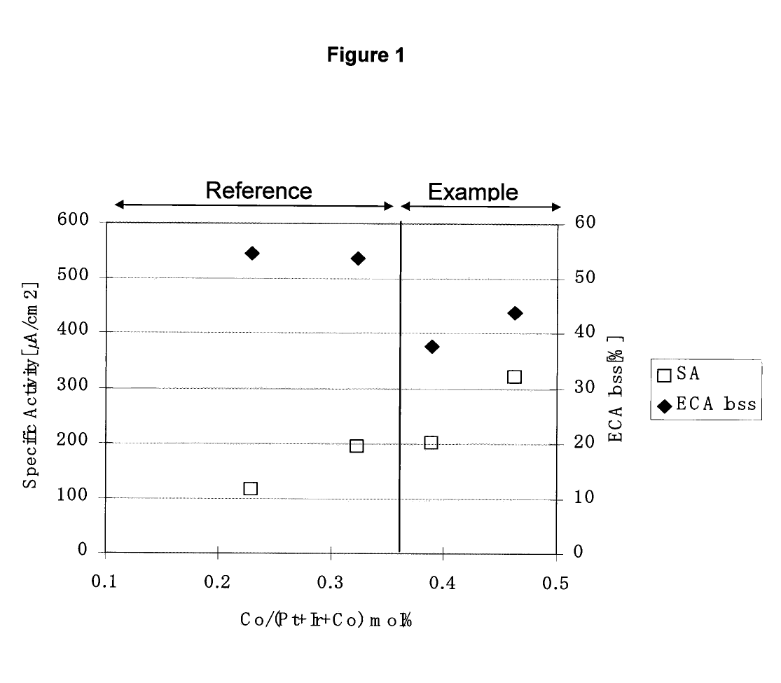

Table 1 compares the specific activity and the ECA loss of catalysts of the present invention, i.e., Examples 1 and 2, and those of reference catalysts References 1 and 2. The catalyst composition is measured using Inductively Coupled Plasma (ICP). The lattice constant and particle size are determined based on X-ray Diffraction spectra. The specific activity is the reaction rate per surface atom of Pt in the unit of μA/cm². The ECA loss is the percentage of the ECA value of the electrocatalyst after 20,000 potential cycles as the ECA value of the electrocatalyst before the potential cycles. The potential cycles were between 0.6 V for 5 sec and 0.95 V for 5 sec at a rate of 10 mV/sec. The same data are also presented in FIG. 1, which shows the changes in specific activity and ECA loss in response to the Co molar percentage in the ternary catalyst.

TABLE 1

| | | | | | | | Specific |
|---|---|---|---|---|---|---|---|
| | | | | Lattice | average | ECA | Activity |
| | Molar ratio (mol %) | | | Constant | particle | loss | (μA/ |
| | Pt | Ir | Co | (Å) | size (Å) | (%) | cm²) |
| Example 1 | balance | 7.4 | 39.1 | 3.81 | 55 | 37.25 | 218.6 |
| Example 2 | balance | 8.3 | 46.3 | 3.80 | 53 | 43.74 | 285.5 |
| Reference | balance | 12.0 | 31.8 | 3.82 | 59 | 44.9 | 148.7 |
| 1 | | | | | | | |
| Reference | balance | 3.5 | 22.9 | 3.87 | 56 | 54.5 | 116.7 |
| 2 | | | | | | | |

Comparing Examples 1 and 2, which have 39.1 mol % and 46.3 mol % of Co respectively, and References 1 and 2, which has 25 mol % and 12.5 mol % of Co, the former has higher specific activities and smaller ECA losses. The lattice constants of the Examples 1 and 2 are also smaller than those of References 1 and 2, indicating shorter Pt—Pt bonds.

The supported catalyst can be applied onto another substrate and used as a fuel cell electrodecatalyst. The PtᵢIrⱼXₖ catalysts of the present invention may be particularly suitable for use as a cathode electrode catalyst in a PAFC fuel cell or a PEMFC fuel cell.

It will be apparent to those skilled in the art that various modifications and variations can be made without departing from the spirit of the invention. The present invention covers all such modifications and variations, provided they come within the scope of the claims and their equivalents.

What is claimed is:

1. An alloy catalyst having a formula of PtᵢIrⱼXₖ,
wherein X is an element selected from the group consisting of Ti, Mn, Co, V, Cr, Ni, Cu, Zr, Zn, and Fe, i is between 40 mol % and 60 mol %, j is between 5 mol % and 20 mol %, and k is between 30 mol % and 50 mol %.

2. The alloy catalyst of claim 1, wherein k is between 35 mol % and 50 mol %.

3. The alloy catalyst of claim 1, wherein j is between 5 mol % and 10%

4. The alloy catalyst of claim 1, wherein i is between 40 mol % and 50 mol %.

5. The alloy catalyst of claim 1, wherein X is Co.

6. The alloy catalyst of claim 1, wherein the alloy catalyst comprises particles provided on a catalyst support material.

7. The alloy catalyst of claim 6, wherein a size of the alloy catalyst particles is 30 Å to 90 Å.

8. The alloy catalyst of claim 6, wherein a weight percentage of the alloy catalyst based on a total weight of the alloy catalyst and the support material is 20 wt % to 60 wt %.

9. The alloy catalyst of claim 1, wherein the catalyst is used as a cathode electrocatalyst in a polymer electrolyte fuel cell or a phosphoric acid fuel cell.

10. A method of synthesizing an alloy catalyst having multiple metal elements, comprising:
mixing one or more of water soluble compounds of the multiple metal elements with a catalyst support material in water to form an aqueous mixture;
adding a reducing agent selected from the group consisting of hydrazine, sodium borohydride, formic acid, and formaldehyde to the aqueous mixture;
evaporating the liquid in the aqueous mixture to obtain a solid material; and
calcining the solid material in an inert atmosphere at 600-1000° C. for 0.5-5 hrs.

11. The method of claim 10, wherein the multiple metal elements comprising platinum, iridium and an element X selected from the group consisting of Ti, Mn, Co, V, Cr, Ni, Cu, Zr, Zn, and Fe.

12. The method of claim 10, wherein the molar percentage of X based on the total amount of metal in the alloy catalyst is between 30 mol % and 50%.

13. The method of claim 10, wherein the molar percentage of X based on the total amount of metal in the alloy catalyst is between 35 mol % and 50%.
